(19) United States
(12) Patent Application Publication
(10) Pub. No.: US 2015/0203705 A1
(43) Pub. Date: Jul. 23, 2015

(54) TWO-COMPONENT POLYURETHANE COATING COMPOSITIONS

(71) Applicant: Bayer MaterialScience LLC, Pittsburgh, PA (US)

(72) Inventors: Ahren Olson, Aliquippa, PA (US); Caitlin Abraham, Steubenville, OH (US)

(73) Assignee: Bayer MaterialScience LLC, Pittsburgh, PA (US)

(21) Appl. No.: 14/160,956

(22) Filed: Jan. 22, 2014

(51) Int. Cl. C09D 133/06

(52) U.S. Cl. CPC C09D 133/066

(57) ABSTRACT

Two-component coating compositions, methods for their preparation and use are disclosed. The two-component coating compositions include an isocyanate-functional component and an isocyanate-reactive component comprising a hydroxyl-functional polymer. The isocyanate-functional component includes: (a) an aliphatic polyisocyanate containing allophanate structural units; and (b) a cycloaliphatic polyisocyanate comprising an allophanate group and an isocyanurate trimer group.

### FIELD OF THE INVENTION

The present invention relates to two-component coating compositions comprising (1) an isocyanate-functional component and (2) an isocyanate-reactive component, as well as polyurethane coatings produced from such compositions.

### BACKGROUND

Two-component coating systems and compositions are widely used because of the many advantageous properties they exhibit. These coating systems generally comprise a liquid binder component and a liquid hardener/crosslinker component. The liquid binder component may comprise an isocyanate-reactive component, such a polyol, and the liquid crosslinker component may comprise a polyisocyanate. The addition reaction of the polyisocyanate with the isocyanate-reactive component produces crosslinked polyurethane networks that form coating films when applied to substrates.

In some applications, sometimes referred to as industrial maintenance applications, a primary objective of the coating is to protect the underlying substrate from corrosion, while still providing a coating with a blister-free appearance. Exemplary substrates in such applications including storage tanks, process vessels, pipework, pumps, building structures, bridge structures, among many others.

Therefore, in industrial maintenance applications, it is often desirable to deposit a relatively thick coating film (3-5 mils dry film thickness) to the substrate to provide the desirable corrosion resistance performance. A historical problem with two-component coating compositions of the type described above, however, has been the tendency of such compositions to develop blistering when applied at such film thicknesses, which is believed to result from the entrapment of carbon dioxide underneath a portion of the at least partially-cured film.

To circumvent this problem, industrial maintenance coating compositions have often been formulated with high styrene-containing acrylic polyols that have a very low percentage of hydroxyl groups. This is believed to help minimize blistering at the aforementioned film thicknesses. A problem with this solution, however, is that these coatings typically do not have the performance characteristics of highly crosslinked polyurethane coatings, such as resistance to exposure to weathering and/or ultraviolet radiation.

As a result, it would be desirable to provide two-component coating compositions that can be applied at the relatively high film thicknesses sought in industrial maintenance applications to provide a highly crosslinked cured polyurethane coating that is substantially free of blistering and is resistant to weathering and/or ultraviolet radiation exposure.

### SUMMARY OF THE INVENTION

In some respects, the present invention is directed to two-component coating compositions. These coating compositions comprise: (1) an isocyanate-functional component, and (2) an isocyanate-reactive component comprising a hydroxyl-functional acrylic polymer and/or a hydroxyl-functional polyester. In these coating compositions, the isocyanate-functional component comprises: (a) an aliphatic polyisocyanate containing allophanate structural units and having the structure:

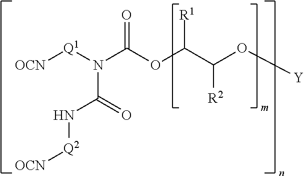

in which Q¹ and Q² independently of one another are the radical of an aliphatic diisocyanate, such as —(CH₂)₆—, R¹ and R² independently of one another are hydrogen or a C₁-C₄ alkyl radical, such as hydrogen and/or methyl, Y is the radical of a starter molecule with a functionality of from 2 to 6, n is a number from 2 to 6, and m corresponds to a number of monomer units such that the number-average molecular weight of the polyether on which the structure is based is 300 to 20,000 g/mol; and (b) a cycloaliphatic polyisocyanate comprising an allophanate group and an isocyanurate trimer group.

In other respects, the present invention is directed to methods for coating a substrate. These methods comprise: (a) combining (1) an isocyanate-functional component with (2) an isocyanate-reactive component comprising a hydroxyl-functional polymer in relative amounts to provide a ratio of isocyanate groups to hydroxyl groups in the combined composition of 0.5 to 5.0:1; and (b) depositing the combined composition over at least a portion of a substrate. In these methods, the isocyanate-functional component comprises: (i) an aliphatic polyisocyanate containing allophanate structural units and having the structure:

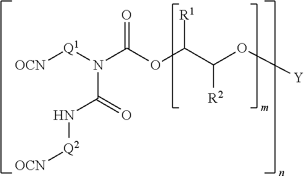

in which Q¹ and Q² independently of one another are the radical of an aliphatic diisocyanate, such as —(CH₂)₆—, R¹ and R² independently of one another are hydrogen or a C₁-C₄ alkyl radical, such as hydrogen and/or methyl, Y is the radical of a starter molecule with a functionality of from 2 to 6, n is a number from 2 to 6, and m corresponds to a number of monomer units such that the number-average molecular weight of the polyether on which the structure is based is 300 to 20,000 g/mol; and (ii) a cycloaliphatic polyisocyanate comprising an allophanate group and an isocyanurate trimer group.

The present invention also relates to, among other things, substrates at least partially coated with a cured coating deposited from such compositions and coated by such methods.

### BRIEF DESCRIPTION OF THE DRAWINGS

FIG. 1 is a bar graph showing blistering resistance (evaluated as dry film thickness before blistering) for coatings prepared from the compositions of Examples 1-4; and

FIG. 2 is a graph showing the UV resistance of coatings deposited from the compositions of Examples 1-4 measured according to ASTM D4587-11 (cycle number 2) as a percentage of initial gloss retained over 4000 hours of exposure to accelerated weathering.

### DETAILED DESCRIPTION OF EMBODIMENTS OF THE INVENTION

Various embodiments are described and illustrated in this specification to provide an overall understanding of the structure, function, operation, manufacture, and use of the disclosed products and processes. It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein includes all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “a”, “an”, and “the”, as used herein, include “at least one” or “one or more”, unless otherwise indicated, even if “at least one” or “one or more” is used in certain instances. Thus, the articles are used herein to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, “polymer” encompasses prepolymers, oligomers and both homopolymers and copolymers; the prefix “poly” in this context referring to two or more. As used herein, the term “molecular weight”, when used in reference to a polymer, refers to the number average molecular weight, unless otherwise specified.

Certain embodiments of the present invention are directed to two-component coating compositions. As used herein, the term “two-component coating composition” refers to a composition comprising at least two components that are stored in separate containers because of their mutual reactivity. One component of such compositions is an isocyanate-functional component and another component of the composition is an isocyanate-reactive component comprising a hydroxyl-functional polymer, such as an acrylic polymer and/or a polyester. The two components are generally not mixed until shortly before application of the composition to a substrate. When the two separate components are mixed and applied as a film on a substrate, the mutually reactive compounds in the two components react to crosslink and form a cured coating film. As used herein, the term “coating composition” refers to a mixture of chemical components that will cure and form a coating when applied to a substrate.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure of the compounds. As used herein, the term “cycloaliphatic” refers to organic compounds characterized by arrangement of carbon atoms in closed ring structures. Cycloaliphatic compounds do not contain aromatic rings as part of the molecular structure of the compounds. Therefore, cycloaliphatic compounds are a subset of aliphatic compounds and thus an aliphatic composition may comprise an aliphatic compound and/or a cycloaliphatic compound.

As used herein the term “diisocyanate” refers to a compound containing two isocyanate groups. As used herein the term “polyisocyanate” refers to a compound containing two or more isocyanate groups. Hence, diisocyanates are a subset of polyisocyanates.

The coating compositions of the present invention comprise an isocyanate-functional component comprising an aliphatic polyisocyanate containing allophanate structural units. In certain embodiments, such an aliphatic polyisocyanate has the structure:

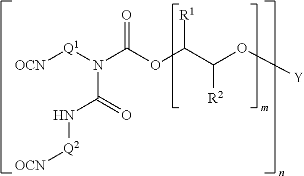

in which Q¹ and Q² independently of one another are the radical of an aliphatic diisocyanate, such as —(CH₂)₆—, R¹ and R² independently of one another are hydrogen or a C₁-C₄ alkyl radical, such as hydrogen and/or methyl, Y is the radical of a starter molecule with a functionality of from 2 to 6, n is a number from 2 to 6, and m corresponds to a number of monomer units such that the number-average molecular weight of the polyether on which the structure is based is 300 to 20,000 g/mol, such as 1000 to 12,000 g/mol or 1000 to 4000 g/mol.

Such aliphatic polyisocyanates can be prepared by a process in which (a) a polyisocyanate is reacted with (b) a polyether polyol containing, for example, less than or equal to 0.02 milliequivalent of unsaturated end groups per gram of polyol (determined according to ASTM D2849-69) and having, for example, a polydispersity (M_{w}/Mₙ) of 1.0 to 1.5 and/or an OH functionality of at least 1.9 to give an isocyanate-functional polyurethane polymer, whose resultant urethane groups are partly or fully allophanatized with further reaction with (c) a polyisocyanate, which may be different from those from (a), and (d) a catalyst and, before, during and/or after the allophanatization, (e) an acidic additive is optionally added.

Suitable aliphatic polyisocyanates from which the foregoing polyisocyanate polymer can be prepared include, but are not limited to, butane diisocyanate (BDI), pentane diisocyanate, hexamethylene diisocyanate (“HDI”), and 4-isocyanatomethyl-1,8-octane diisocyanate (triisocyanatononane, TIN).

The polyether polyols of component (b) have a molecular weight (Mₙ) of from 300 to 20,000 g/mol, such as 1,000 to 12,000 g/mol, or, in some cases, 1,000 to 4,000 g/mol. In some embodiments, such polyether polyols contain ≦50.02, such as ≦50.015, or, in some cases, ≦50.01, milliequivalent of unsaturated end groups per gram of polyol (meq/g), (method of determination ASTM D2849-69). In addition, in certain embodiments, such polyether polyols have a polydispersity (M_{w}/Mₙ) of 1.0 to 1.5 and/or an OH functionality ≧1.9, such as ≧1 .95. In certain embodiments, the polyether polyols have an OH functionalities of <6, such as <4.

Suitable polyether polyols can be prepared, for example, by alkoxylating suitable starter molecules, especially using double metal cyanide catalysts (DMC catalysis) as described, for example, in U.S. Pat. No. 5,158,922 (e.g. Example 30) and EP-A 0 654 302 (p. 5, line 26 to p. 6, line 32), the cited portions of which being incorporated herein by reference.

Examples of suitable starter molecules for preparing a polyether polyol suitable for use in preparing the aliphatic polyisocyanate are simple polyols of low molecular weight, water, organic polyamines having at least two N—H bonds or a mixture thereof. Alkylene oxides suitable for the alkoxylation are, for example, ethylene oxide and/or propylene oxide, which can be used in any order or in a mixture for the alkoxylation. In some embodiments, the starter molecule includes a simple polyol, such as ethylene glycol, propylene 1,3-glycol, butane-1,4-diol, hexane-1,6-diol, neopentyl glycol, 2-ethylhexane-1,3-diol, glycerol, trimethyloipropane, pentaerythritol and/or a low molecular weight, hydroxyl-containing esters of such polyols with dicarboxylic acids and/or low molecular weight ethoxylation or propoxylation products of such simple polyols, or a mixture thereof.

The aliphatic polyisocyanate can be prepared, for example, by first reacting one or more polyether polyols of component (b) with an excess amount of the polyisocyanate from (a) to form an isocyanate-functional polyurethane. The reaction can take place at temperatures of, for example, from 20° C. to 140° C., such as 40° C. to 100° C., with the use where appropriate of a catalyst, such as a tin salt (such as tin(II) bis(2-ethylhexanoate)), an organotin compound (such as dibutyltin dilaurate), and/or a tertiary amine (such as triethylamine and/or diazabicyclooctane).

In certain embodiments, the allophanatization then takes place subsequently by reaction of the isocyanate-functional polyurethane with a polyisocyanate (c), which may be the same as or different from the isocyanate of component (a), with the addition of a suitable catalyst (d) for the allophanatization. This may be followed by the addition, for the purpose of stabilization, of an acidic additive of component (e) and the removal from the product of excess polyisocyanate, by means for example of thin-film distillation or extraction.

The molar ratio of the OH groups of the compounds of component (b) to the NCO groups of the polyisocyanates from (a) and (c) is often 1:1.5 to 1:20, such as 1:2 to 1:15, such as 1:5 to 1:15.

Examples of suitable catalysts for the allophanatization are zinc, tin, potassium, and zirconium compounds, such as Sn(II) salts, including the Sn(II) dihalides, tin or zinc salts, such as Sn(II) bis(2-ethylhexanoate), Sn(II) bis(n-octoate), Zn(II) bis(2-ethylhexanoate) and Zn(II) bis(n-octoate), and also organotin compounds. Examples of suitable catalysts for the allophanatization also include tetraalkylammonium compounds, such as N,N,N-trimethyl-N-2-hydroxy-propylammonium hydroxide, N,N,N-trimethyl-N-2-hydroxypropyl-ammonium 2-ethylhexanoate and choline 2-ethylhexanoate, tetrabutylammonium acetate and benzyltrimethylammonium chloride (BMAC).

The allophanatization catalyst is often used in an amount of up to 5% by weight, based on the overall reaction mixture, such as 5 to 500 ppm of the catalyst, or, in some cases, from 20 to 200 ppm.

Acidic additives of component (e) can be Lewis acids (electron deficiency compounds) or Bronsted acids (protic acids) or compounds which react with water to release such acids. These may, for example, be organic or inorganic acids or else neutral compounds such as acid halides or esters which react with water to form the corresponding acids. Specific examples include, but are not limited to, hydrochloric acid, phosphoric acid, phosphoric esters, benzoyl chloride, isophthaloyl dichloride, p-toluenesulphonic acid, formic acid, acetic acid, dichioroacetic acid and 2-chloropropionic acid.

Where acidic additives are used, they are often organic acids such as carboxylic acids or acid halides such as benzoyl chloride or isophthaloyl dichloride.

The acidic additives are often added at least in an amount such that the molar ratio of the acidic centers of the acidic additives to the catalytically active centers of the catalyst is at least 1:1. In some cases, however, an excess of the acidic additives is added.

Thin-film distillation may be used to separate off excess diisocyanate, and it is often carried out at temperatures from 100 to 160° C. under a pressure of from 0.01 to 3 mbar. The residual monomer content thereafter is often less than 1% by weight, such as less than 0.5% by weight (diisocyanate).

If desired, the process steps can be carried out in the presence of inert an solvent. Inert solvents in this context are those which under the given reaction conditions do not react with the reactants. Examples of suitable inert solvents are ethyl acetate, butyl acetate, methoxypropyl acetate, methyl ethyl ketone, methyl isobutyl ketone, toluene, xylene, aromatic or (cyclo)aliphatic hydrocarbon mixtures or any desired mixtures of such solvents. In some cases, however, the reactions are conducted without solvent.

The components involved, both for the preparation of the prepolymers containing isocyanate groups and for allophanatization, can be added in any order. It is, however, sometimes desirable to add the polyether polyol (b) to an initial charge of the polyisocyanate of components (a) and (c) and then to add the allophanatization catalyst (d).

In some embodiments, the polyisocyanate(s) of components (a) and (c) are charged to a suitable reaction vessel and this initial charge is heated at from 40° C. to 100° C., optionally with stirring. After it has reached the desired temperature, component (b) is added with stirring, and stirring is continued until the NCO content is at or just below the theoretical NCO content of the polyurethane prepolymer that is anticipated in accordance with the chosen stoichiometry. Then, the allophanatization catalyst (d) is added and the reaction mixture is heated at 50° C. and 100° C. until the NCO content is at or just below the desired NCO content. Subsequently, for the purpose of stabilization, component (e) can be added before the reaction mixture is cooled or is passed on directly for thin-film distillation. In that operation, excess polyisocyanate may be separated off at temperatures from 100° C. to 160° C. under a pressure of from 0.01 to 3 mbar down to a residual monomer content of less than 1%, such as less than 0.5%. Following the thin-film distillation it is possible optionally to add further acidic additives of component (e).

The aliphatic polyisocyanate containing allophanate structural units formed as described above has a structure of the general formula:

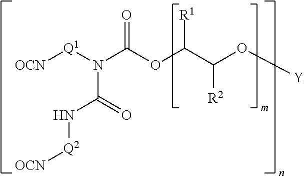

in which Q¹ and Q² independently of one another are the radical of an aliphatic diisocyanate, such as —(CH₂)₆—, R¹ and R² independently of one another are hydrogen or a C₁-C₄ alkyl radical, such as hydrogen and/or methyl, Y is the radical of a starter molecule with a functionality of from 2 to 6, n is a number from 2 to 6 which as a result of the use of different starter molecules need not necessarily be a whole number, and m corresponds to a number of monomer units such that the number-average molecular weight of the polyether on which the structure is based is 300 to 20,000 g/mol, such as 1000 to 12,000 g/mol or 1000 to 4000 g/mol.

In some embodiments, the foregoing aliphatic polyisocyanate containing allophanate structural units has a structure of the general formula:

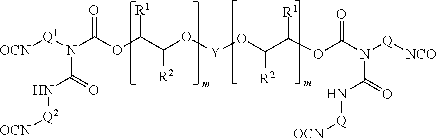

in which Q is the radical of an aliphatic diisocyanate, such as —(CH₂)₆—, R¹ and R² independently of one another are hydrogen or a C₁-C₄ alkyl radical, such as hydrogen and/or methyl, Y is the radical of a difunctional starter molecule and m corresponds to a number of monomer units such that the number-average molecular weight of the polyether on which the structure is based is 300 to 20,000 g/mol, such as 1000 to 12,000 g/mol or 1000 to 4000 g/mol.

In certain embodiments, the aliphatic polyisocyanate containing allophanate structural units has (a) a weight-average molecular weight of from 700 to 50,000 g/mol, such as 1500 to 15,000 g/mol or 1500 to 8000 g/mol; and/or (b) a viscosity at 23° C. of from 500 to 100,000 mPa·s, such as 500 to 50,000 mPa·s, 1000 to 7500 mPa·s or 1000 to 3500 mPa·s.

In certain embodiments, the aliphatic polyisocyanate containing allophanate structural units is derived from HDI and has: (i) an isocyanate functionality of at least 4, a glass transition temperature less than −40° C., and a % NCO less than 10%. Such aliphatic polyisocyanate are free or essentially free of HDI-isocyanurate trimer. Aliphatic polyisocyanates containing allophanate structural units of the type described above, and methods for their preparation, are described in U.S. Pat. No. 7,038,003 B2 at col. 1, In. 55 to col. 6, In. 43, the cited portion of which being incorporated herein by reference.

As previously indicated, the isocyanate-functional component of the coating compositions of the present invention also comprises a cycloaliphatic polyisocyanate comprising an allophanate group and an isocyanurate trimer group.

Such cycloaliphatic polyisocyanates can be prepared by a process comprising (a) catalytically trimerizing a portion of the isocyanate groups of an organic diisocyanate having cycloaliphatically bound isocyanate groups, (b) adding 0.001 to 0.5 moles, per mole of organic diisocyanate, of a monoalcohol to the organic diisocyanate prior to or during the trimerization reaction of step (a), and (c) terminating the trimerization reaction at the desired degree of trimerization by adding a catalyst poison and/or by thermally deactivating the catalyst.

Examples of suitable diisocyanates to be used as starting materials for preparing such cycloaliphatic polyisocyanates according to such a process are organic diisocyanates represented by the formula: R(NCO)₂, wherein R represents an organic group obtained by removing the isocyanate groups from an organic diisocyanate having cycloaliphatically bound isocyanate groups and a molecular weight of 112 to 1,000, such as 140 to 400. In some embodiments, R represents a cycloaliphatic hydrocarbon group having from 5 to 15 carbon atoms. Specific examples of organic diisocyanates which are suitable for use in the process include cyclohexane-1,3-and -1,4-diisocyanate, 1-isocyanato-2-isocyanatomethyl cyclopentane, 1-isocyanato-3-isocyanatomethyl-3,5,5-trimethylcyclohexane (isophorone diisocyanate or IPDI), bis-(4-isocyanatocyclohexyl)-methane, 1,3-and 1,4-bis(isocyanatomethyl)-cyclohexane, and bis-(4-isocyanato-3-methyl-cyclohexyl)-methane, including mixtures thereof.

It is also possible to use blends of the previously mentioned diisocyanates with monoisocyanates or polyisocyanates having 3 or more isocyanate groups, provided that the isocyanate groups are cycloaliphatically bound.

In some embodiments, it may be desirable to treat the starting diisocyanates by bubbling an inert gas such as nitrogen through the starting diisocyanate in order to reduce the content of carbon dioxide.

Trimerization catalysts which are suitable for use in the foregoing process include, for example, phosphines, alkali phenolates, aziridine derivatives in combination with tertiary amines, quaternary ammonium carboxylates, quaternary ammonium phenolates with a zwitterionic structure, ammonium phosphonates and phosphates, alkali carboxylates, basic alkali metal salts complexed with acyclic organic compounds, such as potassium acetate complexed with a polyethylene glycol which contains an average of 5 to 8 ethylene oxide units, basic alkali metal salts complexed with crown ethers, aminosilyl group-containing compounds, such as aminosilanes, diaminosilanes, silylureas and silazanes, mixtures of alkali metal fluorides and quaternary ammonium or phosphonium salts, and Mannich bases, for example, those based on nonylphenol, formaldehyde and dimethylamine.

Suitable trimerization catalysts also include quaternary ammonium hydroxides corresponding to the formula

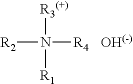

wherein the radicals R₁ to R₄ represent identical or different alkyl groups having from 1 to 20, such as from 1 to 4, carbon atoms, which may optionally be substituted by hydroxyl groups. Two of the radicals R₁-R₄ may form a heterocyclic ring having from 3 to 5 carbon atoms together with the nitrogen atom and optionally with a further nitrogen or oxygen atom. Also, the radicals R₁ to R₃ in each case may represent ethylene radicals which form a bicyclic triethylene diamine structure together with the quaternary nitrogen atom and a further tertiary nitrogen atom, provided that the radical R₄ then represents a hydroxyalkyl group having from 2 to 4 carbon atoms in which the hydroxyl group is arranged in a 2-position to the quaternary nitrogen atom. The hydroxyl-substituted radical or the hydroxyl-substituted radicals may also contain other substituents, such as C₁-C₄ alkoxy substituents.

The production of these quaternary ammonium catalysts can take place by reacting a tertiary amine with an alkylene oxide in an aqueous-alcoholic medium. Examples of suitable tertiary amines include trimethylamine, tributylamine, 2-dimethylaminoethanol, triethanolamine, dodecyldimethylamine, N,N-dimethylcyclohexylamine, N-methylpyrrolidine, N-methylmorpholine and 1,4-diazabicyclo-(2,2,2]-octane. Examples of suitable alkylene oxides are ethylene oxide, propylene oxide, 1,2-butylene oxide, styrene oxide and methoxy, ethoxy or phenoxy propylene oxide. Exemplary catalysts are N,N,N-trimethyl-N-(2-hydroxyethyl)-ammonium hydroxide, N,N,N-trimethyl-N-(2-hydroxypropyl)ammonium hydroxide, and N,N,N-trimethyl-N-benzyl-ammonium hydroxide.

The trimerization of the starting diisocyanates may be carried out in the absence or presence of solvents which are inert to isocyanate groups. Suitable solvents include esters such as ethyl acetate or butyl acetate; ketones such as acetone or 2-butanone; aromatic compounds such as toluene or xylene; halogenated hydrocarbons such as methylene chloride and trichloroethylene; ethers such as diisopropylether; and alkanes such as cyclohexane, petroleum ether or ligroin.

The trimerization catalysts are often used in an amount of 0.0005 to 5% by weight, such as 0.002 to 2% by weight, based on the diisocyanate used.

Urethane groups and subsequently allophanate groups are incorporated into the polyisocyanate by the use of a monoalcohol. In certain embodiments, the monoalcohol comprises a linear, branched or cyclic monoalcohol containing 1 to 5, such as 2 to 5 or 3 to 5 carbon atoms, examples of which include methanol, ethanol, n-propanol, isopropanol, n-butanol, isobutanol and tert-butanol, n-pentanol, 2-hydroxy pentane, 3-hydroxy pentane, the isomeric methyl butyl alcohols, the isomeric dimethyl propyl alcohols, neopentyl alcohol, ethoxy methanol, methoxy ethanol, ethoxy ethanol, the isomeric methoxy or ethoxy propanols, the isomeric propoxy methanols and ethanols, the isomeric methoxy butanols, the isomeric butoxy methanols and furfuralcohol, as described in U.S. Pat. No. 5,124,427 at col. 5, In. 33-50. In certain embodiments, the monoalcohol comprises a linear, branched or cyclic monoalcohol containing 6 to 9, such as 6 or 8 carbon atoms, examples of which include n-hexanol, n-heptanol, n-octanol, n-nonanol, 2-ethyl hexanol, trimethyl hexanol, cyclohexanol and benzyl alcohol, as described in U. S. Pat. No. 5,208,334 at col. 6, In. 2-8. In certain embodiments, the monoalcohol comprises an aromatic monoalcohol containing 6 to 9 carbon atoms, such as phenol, the cresols, the xylenols and the trimethylphenols, as described in U.S. Pat. No. 5,444,146 at col. 5, In. 43-50. In certain embodiments, the monoalcohol comprises a linear, branched or cyclic monoalcohol containing at least 10 carbon atoms and having a molecular weight of 158 to 2500, specific examples of which include hydrocarbon monoalcohols containing 10 to 36, such as 10 to 20 carbon atoms, such as decanol, dodecanol, tetradecanol, hexadecanol, octadecanol, 2,6,8-trimethylnonanol, 2-t-butylcyclohexanol, 4-cyclohexyl-1-butanol, 2,4,6-trimethyl benzyl alcohol, branched chain primary alcohols and mixtures thereof and mixtures of linear primary alcohols, as well as ether-containing monoalcohols having a molecular weight of to 2500 and are based on ethylene oxide, propylene oxide and/or butylene oxide, as described in U.S. Pat. No. 5,235,018 at col. 5, In. 55-68.

In certain embodiments, the molar ratio of monoalcohol to diisocyanate used is 0.01 to 0.5, such as 0.04 to 0.2.

In certain embodiments, the reaction temperature for isocyanurate and allophanate formation is 10° C. to 160° C., such as 50° C. to 150° C. or 90° C. to 120° C.

The process may take place either batchwise or continuously. For example, the starting diisocyanate may be introduced with the exclusion of moisture and optionally with an inert gas into a suitable stirred vessel or tube and optionally mixed with a solvent which is inert to isocyanate groups such as toluene, butyl acetate, diisopropylether or cyclohexane. The monoalcohols(s) may be introduced into the reaction vessel and may be prereacted with the diisocyanate to form urethane groups prior to introducing the diisocyanate into the reaction vessel; the monoalcohol may be mixed with the diisocyanate and introduced into the reaction vessel; the monoalcohol may be separately added to the reaction vessel either before or after the diisocyanate is added; or the catalyst may be dissolved in the monoalcohol prior to introducing the solution into the reaction vessel.

The cycloaliphatic polyisocyanate may also be prepared by blending polyisocyanates containing isocyanurate groups with monoallophonates,

In some embodiments, at a temperature of 60° C. and in the presence of the catalyst or catalyst solution the trimerization begins and is indicated by an exothermic reaction. As the reaction temperature increases the conversion rate of urethane groups to allophanate groups increases faster than the formation of isocyanurate groups. At temperatures above 85° C. when the desired degree of trimerization is achieved, the urethane groups are generally completely converted to allophanate groups and the product, after removal of unreacted monomer and any solvent present has a low viscosity relative to the yield which is obtained. At temperatures below 85° C. at the same degree of isocyanate group consumption, some urethane groups remain unconverted and the product has a slightly higher, but still low viscosity relative to the yield which is obtained. The progress of the reaction is followed by determining the NCO content by a suitable method such as titration, refractive index or IR analysis. Thus, the reaction may be terminated at the desired degree of trimerization. The termination of the trimerization reaction can take place, for example, at an NCO content of 15% to 47%, such as 20 to 40%.

The termination of the trimerization reaction can take place, for example, by the addition of a catalyst-poison. For example, when using basic catalysts the reaction can be terminated by the addition of a quantity, which is at least equivalent to the catalyst quantity, of an acid chloride such as benzoyl chloride. When using heat-labile catalysts, for example, the previously described quaternary ammonium hydroxides, poisoning of the catalyst by the addition of a catalyst-poison may be dispensed with, since these catalysts decompose in the course of the reaction. When using such catalysts, the catalyst quantity and the reaction temperature are often selected such that the catalyst which continuously decomposes is totally decomposed when the desired degree of trimerization is reached. The quantity of catalyst or reaction temperature which is necessary to achieve this decomposition can be determined by a preliminary experiment. It is also possible initially to use a lesser quantity of a heat sensitive catalyst than is necessary to achieve the desired degree of trimerization and to subsequently catalyze the reaction by a further incremental addition of catalyst, whereby the quantity of catalyst added later is calculated such that when the desired degree of trimerization is achieved, the total quantity of catalyst is spent. The use of suspended catalysts is also possible. These catalysts can be removed after achieving the desired degree of trimerization by filtering the reaction mixture.

If desired, any solvent used during trimerization reaction and any unreacted monomer present in the polyisocyanate product can also be removed by distillation. In some embodiments, the cycloaliphatic polyisocyanate contains a total of less than 2%, such as less than 1% of free (unreacted) monomeric diisocyanates. In some embodiments, the cycloaliphatic polyisocyanate has a viscosity at 23° C. of less than 10,000 mPa·s, such as less than 2000 mPa-or less than 1300 mPa·s. In certain embodiments, the ratio of monoisocyanurate groups to monoallophanate groups present in the cycloaliphatic polyisocyanate is 10:1 to 1:5, such as 5:1 to 1:2.

In certain embodiments, the cycloaliphatic polyisocyanate is derived from IPDI and has: (i) an NCO content of 10% to 47% by weight, (ii) a viscosity of less than 10,000 mPas, and (iii) isocyanurate and allophanate groups in a molar ratio of monoisocyanurates to monoallophanates of 10:1 to 1:5. In addition, such IPDI-based cycloaliphatic polyisocyanates may have (i) an average isocyanate functionality of at least 2.3, and/or (ii) a glass transition temperature of 25° C. to 65° C.

Aliphatic polyisocyanates containing allophanate structural units of the type described above, and methods for their preparation, are described in U.S. Pat. Nos. 5,124,427; 5,235,018; 5,208,334; and U.S. Pat. No. 5,444,146, each of which is incorporated in its entirety by reference herein.

In certain embodiments of the coating compositions of the present invention, the cycloaliphatic polyisocyanate (e.g., an IPDI-based cycloaliphatic isocyanate functional material) described above and the aliphatic polyisocyanate described above are combined in a weight ratio ranging from 1:99 to 99:1, such as 95:5 to 50:50, 75:25 to 65:35, or 73:27 to 69:31, these weight ratios being weight of cycloaliphatic polyisocyanate to weight of aliphatic polyisocyanate.

In certain embodiments of the coating compositions of the present invention, the isocyanate-functional component comprises from 50 to 90, such as 50 to 80, 60 to 80, 65 to 75 or 70 weight percent, based on the total weight of isocyanate-functional materials in the isocyanate-functional component, of the cycloaliphatic polyisocyanate (e.g., an IPDI-based cycloaliphatic isocyanate functional material described above) and 10 to 50, such as 10 to 40, 20 to 40, 25 to 35 or 30 weight percent, based on the total weight of isocyanate-functional materials in the isocyanate-functional isocyanate-functional component that component, of the aliphatic polyisocyanate (e.g., an HDI-based aliphatic isocyanate described above); One specific example of such an isocyanate-functional component comprising an IPDI-based cycloaliphatic isocyanate functional material as described above and an HDI-based aliphatic isocyanate prepared as described above, is Desmodur® XP 2763 from Bayer MaterialScience, LLC.

As indicated, the coating compositions of the present invention also comprise an isocyanate-reactive component comprising a hydroxyl-functional polymer, examples of which include acrylic polyols, polyester polyols, polyether polyols, and/or polycarbonate polyols.

In certain embodiments, the coating compositions of the present invention comprise an acrylic polyol. Acrylic polyols suitable for use in the coating compositions of the present invention include hydroxyl-containing copolymers of olefinically unsaturated compounds, such as those polymers that have a number average molecular weight (Mₙ) determined by vapor pressure or membrane osmometry of 800 to 50,000, such as 1000 to 20,000, or, in some cases, 5000 to 10,000, and/or have a hydroxyl group content of 0.1 to 12%, such as 1 to 10% or 2 to 6% by weight, and/or having an acid value of at least 0.1, such as at least 0.5 mg KOH/g and/or up to 10 mg or, in some cases, up to 5 mg KOH/g. Often, the copolymers are based on olefinic monomers containing hydroxyl groups and olefinic monomers which are free from hydroxyl groups. Examples of suitable olefinic monomers that are free of hydroxyl groups include vinyl and vinylidene monomers, such as styrene, a-methyl styrene, o-and p-chloro styrene, o-, m-and p-methyl styrene, p-tert-butyl styrene; acrylic acid; methacrylic acid; (meth)acrylonitrile; acrylic and methacrylic acid esters of alcohols containing 1 to 8 carbon atoms, such as ethyl acrylate, methyl acrylate, n-and iso-propyl acrylate, n-butyl acrylate, 2-ethylhexyl acrylate, 2-ethyihexyl methacrylate, iso-octyl acrylate, methyl methacrylate, ethyl methacrylate, butyl methacrylate and iso-octyl methacrylate; diesters of fumaric acid, itaconic acid or maleic acid having 4 to 8 carbon atoms in the alcohol component; (meth)acrylic acid amide; and vinyl esters of alkane monocarboxylic acids having 2 to 5 carbon atoms, such as vinyl acetate or vinyl propionate. Examples of suitable olefinic monomers containing hydroxyl groups are hydroxyalkyl esters of acrylic acid or methacrylic acid having 2 to 4 carbon atoms in the hydroxyalkyl group, such as 2-hydroxyethyl(meth)acrylate, 2-hydroxypropyl(meth)acrylate, 4-hydroxybutyl(meth)acrylate and trimethylolpropane-mono-or pentaerythritol mono-(meth)acrylate. Mixtures of the monomers may also be used. As will be appreciated, (meth)acrylate and (meth)acrylic is meant to encompass methacrylate and acrylate or methacrylic and acrylics, as the case may be.

In some embodiments, for example, the acrylic polyol comprises a reaction product of reactants comprising: (a) 10 to 40 percent by weight, such as 20 to 30 percent by weight, of one or more vinyl aromatic monomers, such as one or more styrenes; (b) 5 to 40 percent by weight, such as 10 to 25 percent by weight, of one or more olefinic monomers containing hydroxyl groups, such as one or more hydroxyalkyl esters of (meth)acrylic acid having 2 to 4 carbon atoms in the hydroxyalkyl group; (c) 10 to 30 percent by weight, such as 15 to 25 percent by weight, of one or more (meth)acrylic esters of an alcohol containing 1 to 8 carbon atoms, and (d) 0.1 to 2 percent by weight, such as 0.2 to 0.8 percent by weight, of a (meth)acrylic acid, such weights percents being based on the total weight of the reactants used to make the acrylic polymer.

Suitable polyester polyols include those based on mono-, di-and tricarboxylic acids with monomeric di- and triols, and polyester alcohols based on lactones. In some embodiments, the polyester polyol has a number average molecular weight determined by vapor pressure or membrane osmometry of 800 to 50,000, such as 1000 to 20,000, or, in some cases, 5000 to 10,000. Some embodiments of the coating compositions of the present invention comprise an acrylic polyol of the type described above and a polyester polyol of the type described above.

Suitable polyether polyols are obtainable, for example, by polymerization of cyclic ethers or by reaction of alkylene oxides with a starter molecule. Suitable polycarbonate polyols can be obtained by reaction of diols, lactone-modified diols or bisphenols, e.g. bisphenol A, with phosgene or carbonic acid diesters, such as diphenyl carbonate or dimethyl carbonate.

The two-component coating compositions described herein may comprise any of a variety of conventional auxiliary agents or additives, such as defoamers, rheology modifiers (e.g., thickeners), leveling agents, flow promoters, pigments, moisture scavengers, dispersing agents, catalysts, anti-skinning agents, anti-sedimentation agents, and/or emulsifiers.

In some embodiments, the two-component coating systems or compositions of the present invention are organic solvent-borne compositions. As used herein, “organic solvent-borne composition” means that the composition comprises one or more volatile organic compounds (“VOC”) as the primary diluent, i.e., greater than 50% of the diluent in the composition is VOC. Exemplary VOCs are aromatic hydrocarbons, such as toluene and xylene; ketones, such as methyl ethyl ketone and methyl isobutyl ketone; alcohols, such as isopropyl alcohol, normal-butyl alcohol and normal-propyl alcohol; monoethers of glycols, such as the monoethers of ethylene glycol and diethylene glycol; monoether glycol acetates, such as 2-ethoxyethyl acetate; as well as compatible mixtures thereof.

The two-component coating compositions described herein are prepared by combining the isocyanate-functional component with the isocyanate-reactive component in relative amounts to provide a ratio of isocyanate groups to hydroxyl groups in the combined composition of 1:5 to 5:1, such as 1:3 to 3:1, 1:2 to 2:1, 1:1.5 to 1.5:1, 0,5:1 to 5:1, 1.5:1 to 3:1, or 1:1 to 1.5:1.

The coating compositions described herein may be applied on to surfaces using various techniques, such as spraying, dipping, flow coating, rolling, brushing, pouring, and the like. Any solvents present in the applied coating evaporate, and the coating cures due to the urethane-forming crosslinking reaction between the polyisocyanates and the hydroxy-functional components. The crosslinking reactions may occur under ambient conditions or at higher temperatures of, for example, 40° C. to 200° C. In certain embodiments, the coating composition is applied in a relatively thick film, such that the cured coating has a dry film thickness of at least 3 mils (at least 76.2 μm), such as 3 to 6 mils (76.2 μm to 152.4 μm), or 3 to 5 mils (76.2 μm to 127 μm). The coating compositions of the present invention are to be distinguished from moisture-curable compositions that contain sufficient free isocyanate groups that react with atmospheric moisture to produce insoluble and relatively high-molecular weight cross-linked polyurethane networks. In the present coating compositions, the high-molecular weight cross-linked polyurethane network is formed by reaction of an isocyanate-functional component with an isocyanate-reactive component that comprises a hydroxyl-functional polymer, such as an acrylic polymer and/or a polyester.

The coating compositions can be applied onto any compatible substrate, such as, for example, metals, plastics, ceramics, glass, and natural materials, and to substrates that have been subjected to any pre-treatment that may be desirable. In certain embodiments, the substrate comprises a storage tank, a process vessel, pipework, a pump, a building structure, or a bridge structure.

Embodiments of the present invention are also directed to methods for coating a substrate, which comprise: (a) combining (1) an isocyanate-functional component with (2) an isocyanate-reactive component comprising a hydroxyl-functional polymer in relative amounts to provide a ratio of isocyanate groups to hydroxyl groups in the combined composition of 0.5 to 5.0:1; and (b) depositing the combined composition over at least a portion of a substrate. In these methods, the isocyanate-functional component comprises: (i) an aliphatic polyisocyanate containing allophanate structural units and having the structure:

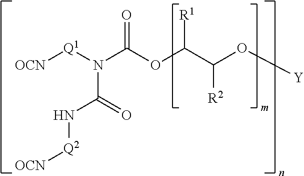

in which Q¹ and Q² independently of one another are the radical of an aliphatic diisocyanate, such as —(CH₂₆—, R¹ and R² independently of one another are hydrogen or a C₁-C₄ alkyl radical, such as hydrogen and/or methyl, Y is the radical of a starter molecule with a functionality of from 2 to 6 (accordingly n is a number from 2 to 6), and m corresponds to a number of monomer units such that the number-average molecular weight of the polyether on which the structure is based is 300 to 20,000 g/mol, such as 1000 to 12,000 g/mol or 1000 to 4000 g/mol; and (ii) a cycloaliphatic polyisocyanate comprising an allophanate group and an isocyanurate trimer group. As used herein, when it is stated that a composition is deposited “over at least a portion of a substrate” it means that the composition is applied either (i) directly on the substrate with no intervening coatings between the substrate and the composition or (ii) on a previously coated substrate so that one or more coatings, such as, for example, a conversion coating and/or primer coating, is disposed between the substrate and the composition.

An advantage of the two-component coating compositions of the present invention is that they can provide cured coatings that are substantially-free of blisters even when deposited in relatively thick films. As will be appreciated, in general, the greater the thickness of an applied liquid coating, the greater the tendency of the applied coating to blister during cure. The occurrence of blistering in an applied coating composition may adversely affect various coating properties, such as, for example, uniformity of thickness, gloss, and weatherability.

Blistering resistance may be quantified by measuring the film build to blister (“FBTB”) of a coating composition in a manner described in the Examples. Some embodiments of the cured coatings deposited from a composition of the present invention exhibit a FBTB of at least 140 microns when evaluated 24 hours after deposition on the substrate and maintained at 72° F. and 50% relative humidity.

Another advantage of the two-component coating compositions of the present invention is that, in addition to the blistering resistance described above, they can provide a cured coating that is also resistant to weathering. As will be appreciated, weathering resistance may be evaluated according to ASTM D 4587 and/or ASTM D 1014. Some embodiments of cured coatings deposited from a coating compositions of the present invention may exhibit a % gloss retention after 4000 hours of accelerated weathering conditions according to ASTM D4587-11 (cycle number 2) of at least 50%, at least 60%, at least 70%, at least 80%, or, in some cases, at least 90% and/or a % gloss retention of at least 75% after 2000 hours of such accelerated weathering conditions.

As will be appreciated from the foregoing, embodiments of the present invention are directed to two-component coating composition comprising: (1) an isocyanate-functional component, and (2) an isocyanate-reactive component comprising a hydroxyl-functional acrylic polymer and/or a hydroxyl-functional polyester, wherein the isocyanate-functional component comprises: (a) an aliphatic polyisocyanate containing allophanate structural units and having the structure:

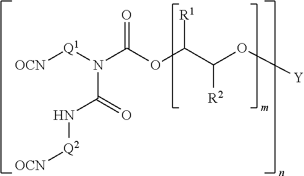

in which: (i) Q¹ and Q² independently of one another are the radical of an aliphatic diisocyanate, (ii) R¹ and R² independently of one another are hydrogen or a C₁-C₄ alkyl radical, (iii) Y is the radical of a starter molecule with a functionality of from 2 to 6, (iv) n is a number from 2 to 6, and (v) m corresponds to a number of monomer units such that the number-average molecular weight of the polyether on which the structure is based is 300 to 20,000 g/mol, such as 1000 to 12,000 g/mol or 1000 to 4000 g/mol; and (b) a cycloaliphatic polyisocyanate comprising an allophanate group and an isocyanurate trimer group.

Some embodiments of the present invention are directed to a two-component coating composition of the previous paragraph, wherein the aliphatic polyisocyanate containing allophanate structural units corresponds to the general formula:

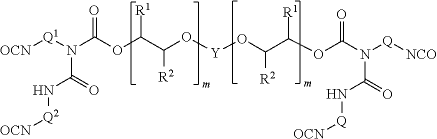

in which Q is the radical of an aliphatic diisocyanate, such as —(CH₂)₆—.

Embodiments of the present invention are also directed to a two-component coating composition of any of the previous two paragraphs, wherein the aliphatic polyisocyanate containing allophanate structural units has an isocyanate functionality of at least 4, a glass transition temperature less than −40° C., and a % NCO less than 10%.

Certain embodiments of the present invention are directed to a two-component coating composition of any of the previous three paragraphs, wherein the cycloaliphatic polyisocyanate is derived from isophorone diisocyanate and has: (i) an NCO content of 10% to 47% by weight, (ii) a viscosity of less than 10,000 mPas, and (iii) isocyanurate and allophanate groups in a molar ratio of monoisocyanurates to monoallophanates of 10:1 to 1:5.

Some embodiments of the present invention are directed to a two-component coating composition of any of the previous four paragraphs, wherein the isocyanate-functional component comprises: (a) 50 to 90, 50 to 80, 60 to 80, 65 to 75 or 70 weight percent, based on the total weight of isocyanate-functional materials in the isocyanate-functional component, of the cycloaliphatic polyisocyanate, and (b) 10 to 50, 10 to 40, 20 to 40, 25 to 35 or 30 weight percent, based on the total weight of isocyanate-functional materials in the isocyanate-functional component, of the aliphatic polyisocyanate.

Embodiments of the present invention are also directed to a two-component coating composition of any of the previous five paragraphs, wherein the isocyanate-reactive component comprising a hydroxyl-functional acrylic polymer, such as a hydroxyl-functional acrylic polymer comprises a reaction product of reactants comprising: (a) 10 to 40 percent by weight of one or more vinyl aromatic monomers; (b) 5 to 40 percent by weight of one or more olefinic monomers containing hydroxyl groups; (c) 10 to 30 percent by weight of one or more (meth)acrylic esters of an alcohol containing 1 to 8 carbon atoms, and (d) 0.1 to 2 percent by weight of one or more (meth)acrylic acids, wherein the weights percents are based on the total weight of the reactants used to make the acrylic polymer.

In certain embodiments, the present invention is directed to a two-component coating composition of any of the previous six paragraphs, wherein the isocyanate-functional component and the isocyanate-reactive component are present in amount such that ratio of isocyanate groups to hydroxyl groups in the composition is 0.5:1 to 5:1, such as 1:3 to 3:1, 1:2 to 21, 1:1.5 to 1.5:1, 0.5:1 to 5:1, 1.5:1 to 3:1, or 1:1 to 1.5:1.

Embodiments of the present invention are also directed to a method of using a two-component coating composition of any of the previous seven paragraphs, comprising applying the coating composition to a substrate (such as a storage tank, a process vessel, pipework, a pump, a building structure, or a bridge structure) such that the cured coating has a dry film thickness of at least 3 mils, such as 3 to 6 mils, or 3 to 5 mils.

Certain embodiments of the present invention are directed to a method for coating a substrate, comprising: (a) combining (1) an isocyanate-functional component with (2) an isocyanate-reactive component comprising a hydroxyl-functional polymer in relative amounts to provide a ratio of isocyanate groups to hydroxyl groups in the combined composition of 0.5 to 5.0:1, such as 1:3 to 3:1, 1:2 to 2:1, 1:1.5 to 1.5:1, 0.5:1 to 5:1, 1.5:1 to 3:1, or 1:1 to 1.5:1; and (b) depositing the combined composition over at least a portion of a substrate, wherein the isocyanate-functional component comprises: (i) an aliphatic polyisocyanate containing allophanate structural units and having the structure:

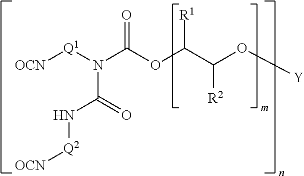

in which Q¹ and Q² independently of one another are the radical of an aliphatic diisocyanate, such as —(CH₂)₆—, R¹ and R² independently of one another are hydrogen or a C₁-C₄ alkyl radical, Y is the radical of a starter molecule with a functionality of from 2 to 6, n is a number from 2 to 6, and m corresponds to a number of monomer units such that the number-average molecular weight of the polyether on which the structure is based is 300 to 20,000 g/mol, such as 1000 to 12,000 g/mol or 1000 to 4000 g/mol; and (ii) a cycloaliphatic polyisocyanate comprising an allophanate group and an isocyanurate trimer group.

Some embodiments of the present invention are directed to a method of the previous paragraph, wherein the aliphatic polyisocyanate is prepared by a process comprising: (1) reacting a polyisocyanate (a) and a polyether polyol (b) that contains less than or equal to 0.02 milliequivalent of unsaturated end groups per gram of polyol, has a polydispersity of from 1.0 to 1.5 and an OH functionality of at least 1.9 to give an isocyanate-functional polyurethane polymer, and (2) partly or fully allophanatizing the urethane groups of the isocyanate-functional polyurethane polymer by further reaction with a polyisocyanate.

In some embodiments, the present invention is directed to a method of any of the previous two paragraphs, wherein the aliphatic polyisocyanate containing allophanate structural units corresponds to the general formula:

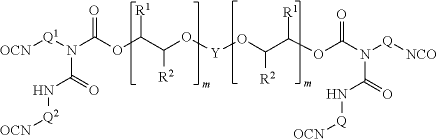

in which Q is —(CH₂₆—.

Embodiments of the present invention are also directed to a method of any of the previous three paragraphs, wherein the cycloaliphatic polyisocyanate is derived from isophorone diisocyanate and has: (i) an NCO content of 10% to 47% by weight, (ii) a viscosity of less than 10,000 mPas, and (iii) isocyanurate and allophanate groups in a molar ratio of monoisocyanurates to monoallophanates of 10:1 to 1:5.

Some embodiments of the present invention are directed to a method of any of the previous four paragraphs, wherein the isocyanate functional component comprises: (a) 50 to 90, 50 to 80, 60 to 80, 65 to 75 or 70 percent by weight, based on the total weight of isocyanate-functional materials in the isocyanate-functional component, of the cycloaliphatic polyisocyanate; and (b) 10 to 50, 10 to 50, 10 to 40, 20 to 40, 25 to 35 or 30 percent by weight, based on the total weight of isocyanate-functional materials in the isocyanate-functional component, of the aliphatic polyisocyanate.

Certain embodiments of the present invention are directed to a method of any of the previous five paragraphs, wherein the isocyanate-reactive component comprising a hydroxyl-functional acrylic polymer, such as a hydroxyl-functional acrylic polymer comprises a reaction product of reactants comprising: (a) 10 to 40 percent by weight of one or more vinyl aromatic monomers; (b) 5 to 40 percent by weight of one or more olefinic monomers containing hydroxyl groups; (c) 10 to 30 percent by weight of one or more (meth)acrylic esters of an alcohol containing 1 to 8 carbon atoms, and (d) 0.1 to 2 percent by weight of one or more (meth)acrylic acids, wherein the weights percents are based on the total weight of the reactants used to make the acrylic polymer.

Illustrating the invention are the following examples that do not limit the invention to their details. All parts and percentages in the examples, as well as throughout the specification, are by weight unless otherwise indicated.

### EXAMPLES

### Example 1

Coating compositions were prepared using the ingredients and amounts (in parts by weight) listed in Table 1. To prepare Component I, the Grind components were weighed into a pint can and sheared with a high-speed mixer using a Cowles disperser blade until a Hegman grind of 6 or greater was observed. After grinding, the Letdown components were added while stirring at a reduced stir rate to form Component I. Component I was then combined with Component II while stirring, prior to application. Example 1A is a comparative example and Example 1B is an inventive example. Formulation results are set forth in Table 2.

TABLE 1

| | | |
|---|---|---|
| | Example 1A | Example 1B |
| Raw Material | Weight | Weight |

Component I
Grind

| | | |
|---|---|---|
| Desmophen ® A 870 BA¹ | 37.3 | 32.7 |
| Byk ®-358N² | 0.8 | 0.7 |
| Ti-Pure ® R-960³ | 29.1 | 25.5 |
| Byk ®-077⁴ | 1.2 | 1.0 |
| Disperbyk ®-110⁵ | 1.2 | 1.0 |
| Ircothix ® 2000⁶ | 3.4 | 2.9 |
| Irganox ® 1010⁷ | 0.4 | 0.4 |

Letdown

| | | |
|---|---|---|
| Ektapro ® EEP⁸ | 7.2 | 6.3 |
| Methyl n-amyl ketone | 3.5 | 3.1 |
| Tinuvin ® 292⁹ | 0.4 | 0.4 |
| SubTotal Component I | 84.4 | 73.9 |

Component II

| | | |
|---|---|---|
| Desmodur ® XP 2763¹⁰ | — | 26.1 |
| Desmodur ® N-3390 BA/SN¹¹ | 15.6 | — |
| Subtotal Component II | 15.6 | 26.1 |
| Total | 100.0 | 100.0 |

¹Hydroxyl functional polyacrylate dissolved in n-butyl acetate having a hydroxyl content of 2.95 wt. %, available from Nuplex Resins
²Surface additive available from BYK-Chemie GmbH
³Titanium dioxide pigment available from DuPont
⁴Leveling additive available from BYK-Chemie GmbH
⁵Wetting and dispersing additive available from BYK-Chemie GmbH
⁶Rheology modifier available from Lubrizol Advanced Materials Inc.
⁷Antioxidant available from BASF
⁸Ethyl 3-Ethoxypropionate solvent available from Eastman Chemical Company
⁹hindered-amine light stabilizer available from BASF
¹⁰An aliphatic polyisocyanate based on IPDI and HDI supplied in butyl acetate having an NCO content of 10.2% from Bayer MaterialScience LLC.
¹¹An aliphatic polyisocyanate based on hexamethylene diisocyanate and dissolved in n-butyl acetate and aromatic 100 (1:1), having an NCO content of 17.8 wt. %, available from Bayer MaterialScience LLC.

TABLE 2

| Result | Example 1A | Example 1B |
|---|---|---|
| Weight Solids | 72.6 | 73.7 |
| PVC | 17.3 | 13.7 |
| NCO:OH | 1.1:1 | 1.1:1 |
| Mix Ratio (vol) | 4.58:1 | 2.24:1 |
| P/B | 0.7 | 0.6 |
| % NCO | 31.0% | 28.0% |
| Volume Solids | 59.4% | 62.6% |
| Wt/Gal (lbs/gal) | 10.8 | 10.4 |
| VOC (lbs/gal) | 3.0 | 2.7 |

### Example 2

Coating compositions were prepared using the ingredients and amounts (in parts by weight) listed in Table 3 according to the procedure of Example 1. Example 2A is a comparative example and Example 2B is an inventive example. Theoretical results are set forth in Table 4.

TABLE 3

| | | |
|---|---|---|
| | Example 2A | Example 2B |
| Raw Material | Weight | Weight |

Component I
Grind

| | | |
|---|---|---|
| Desmophen ® A 160 SN¹² | 41.6 | 39.0 |
| Aerosil ® R972¹³ | 0.5 | 0.4 |
| Ti-Pure ® R-960³ | 29.5 | 27.6 |
| Disperbyk ® 161¹⁴ | 1.3 | 1.2 |
| Bentone ® 38 Gel | 4.9 | 4.6 |
| (10% in A-100)¹⁵ | | |
| Byk ®-141¹⁶ | 0.4 | 0.4 |

Letdown

| | | |
|---|---|---|
| Tinuvin ® 292⁹ | 0.4 | 0.4 |
| Aromatic 100 solvent | 10.5 | 9.9 |
| SubTotal Component I | 89.0 | 83.4 |

Component II

| | | |
|---|---|---|
| Desmodur XP 2763¹⁰ | — | 16.6 |
| Desmodur N-75 BA/X¹⁷ | 11.0 | — |
| Subtotal Component II | 11.0 | 16.6 |
| Total | 100.0 | 100.0 |

¹²A hydroxyl functional polyacrylate dissolved in aromatic 100 having a hydroxyl content of 2.7 wt. %, available from Nuplex Resins.
¹³Fumed silica available from Evonik Industries
¹⁴Wetting and dispersing additive available from BYK-Chemie GmbH
¹⁵Rheology additive available from Elementis Specialties, Inc.
¹⁶Defoamer available from BYK-Chemie GmbH
¹⁷Aliphatic polyisocyanate based on HDI and dissolved in n-butyl acetate and xylene (1:1), having an NCO content of 16.5 wt. %, available from Bayer MaterialScience LLC.

TABLE 4

| Results | Example 2A | Example 2B |
|---|---|---|
| Weight Solids | 64.5 | 67.0 |
| PVC | 20.5 | 17.4 |
| NCO:OH | 1.1 | 1.1 |
| Mix Ratio (vol) | 6.65:1 | 4.11:1 |
| P/B | 0.9 | 0.7 |
| % NCO | 17.0% | 15.0% |
| Volume Solids | 49.0% | 53.2% |
| Wt/Gal (lbs/gal) | 10.5 | 10.4 |
| VOC (lbs/gal) | 3.7 | 3.4 |

### Example 3

Coating compositions were prepared using the ingredients and amounts (in parts by weight) listed in Table 5 according to the procedure of Example 1. Example 3A is a comparative example and Example 3B is an inventive example. Theoretical results are set forth in Table 6.

TABLE 5

| | | |
|---|---|---|
| | Example 3A | Example 3B |
| Raw Material | Weight | Weight |

Component I
Grind

| | | |
|---|---|---|
| Desmophen ® XP-7116¹⁸ | 26.0 | 22.7 |
| Nytal ® 400¹⁹ | 9.2 | 8.1 |
| Byk-358N² | 0.7 | 0.6 |
| Ti-Pure R-960³ | 27.7 | 24.2 |
| Byk-077⁴ | 1.0 | 0.8 |
| Disperbyk-110⁵ | 1.1 | 1.0 |
| Ircogel 906²⁰ | 4.7 | 4.1 |

Letdown

| | | |
|---|---|---|
| Tinuvin ® 292⁹ | 0.4 | 0.3 |
| Tinuvin ® 1130²¹ | 0.7 | 0.6 |
| Ektapro EEP⁸ | 8.9 | 7.8 |
| Methyl n-amyl ketone | 3.5 | 3.1 |
| Desmorapid ® PP²² | 0.3 | 0.3 |
| SubTotal Component I | 84.1 | 73.5 |

Component II

| | | |
|---|---|---|
| Desmodur XP 2763¹⁰ | — | 26.5 |
| Desmodur N-3390 BA/SN²³ | 15.9 | — |
| Subtotal Component II | 15.9 | 26.5 |
| Total | 100.0 | 100.0 |

¹⁸A hydroxy-functional saturated polyester resin supplied in n-butyl acetate from Bayer MaterialScience LLC
¹⁹Talc available from R. T. Vanderbilt Company, Inc.
²⁰Rheology modifier available from Lubrizol Advanced Materials Inc.
²¹UV absorber available from BASF
²²long chain tertiary amine catalyst available from Lanxess Corporation
²³Aliphatic polyisocyanate based on hexamethylene diisocyanate and dissolved in n-butyl acetate and aromatic 100 (1:1), having an NCO content of 17.8 wt. %, available from Bayer MaterialScience LLC.

TABLE 6

| Results | Example 1 | Example 2 |
|---|---|---|
| Weight Solids | 77.6 | 78.1 |
| PVC | 26.3 | 20.3 |
| NCO:OH | 11 | 1.1 |
| Mix Ratio (vol) | 3.90:1 | 1.92:1 |
| P/B | 1.1 | 0.8 |
| % NCO | 26.0% | 23.0% |
| Volume Solids | 63.8% | 66.6% |
| Wt/Gal (lbs/gal) | 12.1 | 11.4 |
| VOC (lbs/gal) | 2.7 | 2.5 |

### Example 4

Coating compositions were prepared using the ingredients and amounts (in parts by weight) listed in Table 7 according to the procedure of Example 1. Example 4A is a comparative example and Example 4B is an inventive example. Theoretical results are set forth in Table 8.

TABLE 7

| | | |
|---|---|---|
| | Example 4A | Example 4B |
| Raw Material | Weight | Weight |

Component I
Grind

| | | |
|---|---|---|
| Desmophen ® A 665 BA/X²⁴ | 31.7 | 27.5 |
| Anti-Terra ®-U²⁵ | 0.2 | 0.2 |
| Ti-Pure ® R-960³ | 38.8 | 33.7 |
| Bentone ® 34 Gel | 2.8 | 2.4 |
| (10% in A-100)²⁶ | | |
| Dow Corning ® 56 Additive | 0.6 | 0.5 |
| (1% in Exxate 600)²⁷ | | |

Letdown

| | | |
|---|---|---|
| Tinuvin ® 292⁹ | 0.4 | 0.3 |
| Tinuvin ® 1130²¹ | 0.8 | 0.7 |
| Exxate ™ 600²⁸ | 9.4 | 8.2 |
| Methyl n-amyl ketone | 1.8 | 1.6 |
| SubTotal Component I | 86.4 | 75.1 |

Component II

| | | |
|---|---|---|
| Desmodur XP 2763¹⁰ | — | 24.9 |
| Desmodur N-3300²⁹ | 13.6 | — |
| SubTotal Component II | 13.6 | 24.9 |
| Total | 100.0 | 100.0 |

²⁴A hydroxyl functional polyacrylate dissolved in n-butyl acetate and xylene (1:1) having a hydroxyl content of 4.6%, available from Nuplex Resins
²⁵Wetting and dispersing additive available from BYK-Chemie GmbH
²⁶Rheology additive available from Elementis Specialties, Inc.
²⁷Anti-foam agent available from Dow Corning Corporation
²⁸Solvent from ExxonMobil Chemical
²⁹Aliphatic polyisocyanate based on HDI, having an NCO content of 21.8 wt. %, available from Bayer MaterialScience LLC.

TABLE 8

| Results | Example 4A | Example 4B |
|---|---|---|
| Weight Solids | 76.2 | 75.8 |
| PVC | 24.3 | 19.2 |
| NCO:OH | 1.1 | 1.1 |
| Mix Ratio (vol) | 5.00:1 | 2.14:1 |
| P/B | 1.1 | 0.8 |
| % NCO | 27.0% | 23.0% |
| Volume Solids | 60.8% | 62.6% |
| Wt/Gal (lbs/gal) | 12.0 | 11.3 |
| VOC (lbs/gal) | 2.9 | 2.7 |

### Coating Application and Testing

The coating compositions of Examples 1-4 were spray applied to chromated aluminum panels using a high-volume, low pressure spray gun. For evaluation of blistering resistance, panels were cured overnight at two conditions: 72° F. and 50% relative humidity and 95° F. and 55% relative humidity. The cured panels were thereafter evaluated for blistering. For evaluation of weathering resistance, coated panels were cured at 72° F. and 50% relative humidity for 14 days to provide a cured coating with a dry film thickness of 3 mils, which was then placed in the QUV-A chamber.

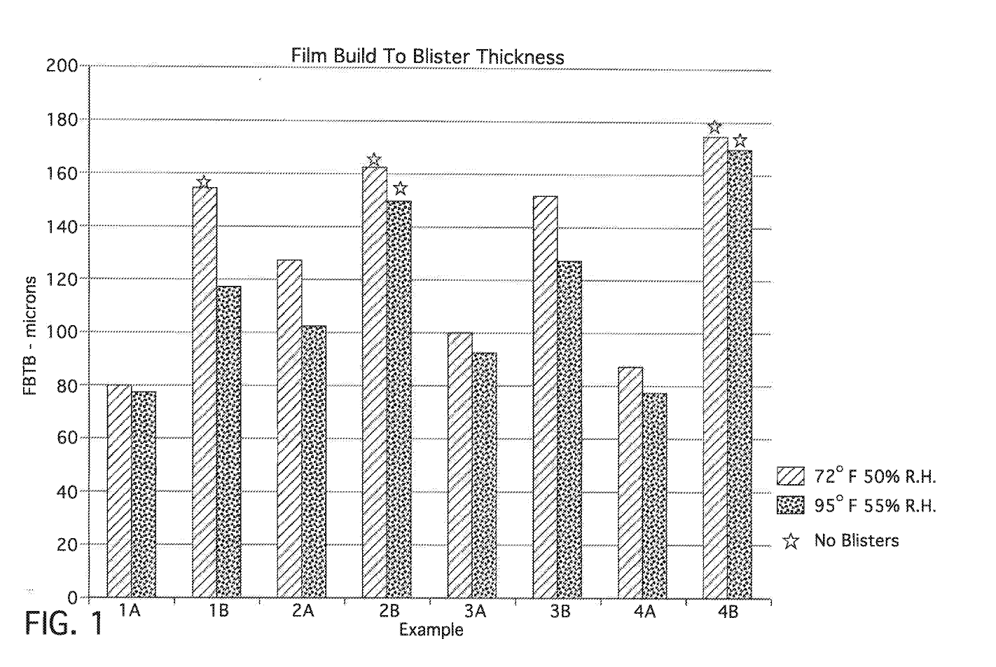

Cured coatings deposited from the coating compositions of Examples 1-4 were evaluated for blistering resistance (evaluated as dry film thickness before blistering) by measuring the film build to blister (“FBTB”) of a coating deposited from the coating composition. The FBTB of a coating is the greatest dry film thickness of a cured coating that does not exhibit any blistering that is observable with the naked eye on a panel having the coating applied with a thickness gradient. A coating composition is applied to a panel from a relatively thin to relatively thick build. For example, a coating composition may be applied with a constant thickness gradient so that the cured coating has a dry film thickness of 2 mils at one end of the panel and 12 mils at the other end. If the cured coating exhibits observable blistering at 7 mils dry film thickness, then the FBTB is 6 mils and the coating may be said to exhibit no substantial blistering when applied at a dry film thickness of at least 6 mils. The results are illustrated in FIG. 1.

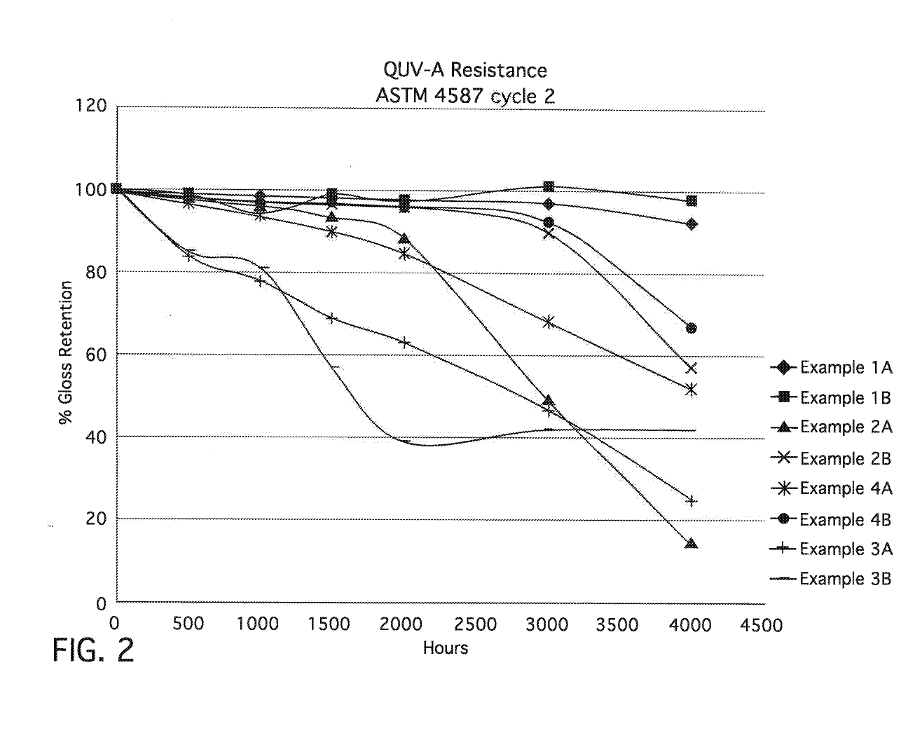

Weathering resistance, measured as % gloss retention after exposure to accelerated weathering conditions according to ASTM 04587-11 (cycle number 2), of coatings deposited from the compositions of Examples 1-4 was evaluated. Results are illustrated in FIG. 2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A two-component coating composition comprising:
(1) an isocyanate-functional component, and
(2) an isocyanate-reactive component comprising a hydroxyl-functional acrylic polymer and/or a hydroxyl-functional polyester,
wherein the isocyanate-functional component comprises:
(a) an aliphatic polyisocyanate containing allophanate structural units and having the structure: 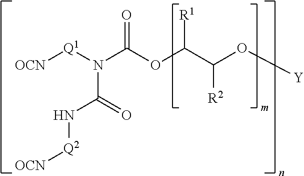
in which: (i) Q¹ and Q² independently of one another are the radical of an aliphatic diisocyanate, (ii) R¹ and R² independently of one another are hydrogen or a C₁-C₄ alkyl radical, (iii) Y is the radical of a starter molecule with a functionality of from 2 to 6, (iv) n is a number from 2 to 6, and (v) m corresponds to a number of monomer units such that the number-average molecular weight of the polyether on which the structure is based is 300 to 20,000 g/mol; and
(b) a cycloaliphatic polyisocyanate comprising an allophanate group and an isocyanurate trimer group.

2. The two-component coating composition of claim 1, wherein the aliphatic polyisocyanate containing allophanate structural units corresponds to the general formula: 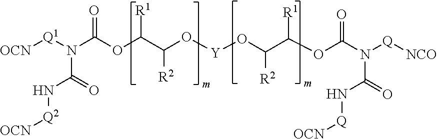
in which Q is the radical of an aliphatic diisocyanate.

3. The two-component coating composition of claim 2, in which Q is —(CH₂)₆—.

4. The two-component coating composition of claim 1, wherein the aliphatic polyisocyanate has an isocyanate functionality of at least 4, a glass transition temperature less than −40° C., and a % NCO less than 10%.

5. The two-component coating composition of claim 1, wherein the cycloaliphatic polyisocyanate is derived from isophorone diisocyanate and has: (i) an NCO content of 10% to 47% by weight, (ii) a viscosity of less than 10,000 mPas, and (iii) isocyanurate and allophanate groups in a molar ratio of monoisocyanurates to monoallophanates of 10:1 to 1:5.

6. The two-component coating composition of claim 1, wherein the isocyanate-functional component comprises: (a) 50 to 90 weight percent, based on the total weight of isocyanate-functional materials in the isocyanate-functional component, of the cycloaliphatic polyisocyanate, and (b) 10 to 50 weight percent, based on the total weight of isocyanate-functional materials in the isocyanate-functional component, of the aliphatic polyisocyanate.

7. The two-component coating composition of claim 1, wherein the isocyanate-reactive component comprises a hydroxyl-functional acrylic polymer.

8. The two-component coating composition of claim 7, wherein the hydroxyl-functional acrylic polymer comprises a reaction product of reactants comprising:
(a) 10 to 40 percent by weight of one or more vinyl aromatic monomers;
(b) 5 to 40 percent by weight of one or more olefinic monomers containing hydroxyl groups;
(c) 10 to 30 percent by weight of one or more (meth)acrylic esters of an alcohol containing 1 to 8 carbon atoms; and
(d) 0.1 to 2 percent by weight of one or more (meth)acrylic acids,
wherein the weight percents are based on the total weight of the reactants used to make the acrylic polymer.

9. The two-component coating composition of claim 1, wherein the isocyanate-functional component and the isocyanate-reactive component are present in amounts such that the ratio of isocyanate groups to hydroxyl groups in the composition is 0.5:1 to 5:1.

10. A method of using the two-component coating composition of claim 1, comprising applying the coating composition to a substrate such that the cured coating has a dry film thickness of at least 3 mils.

11. The method of claim 10, wherein the substrate comprises a storage tank, a process vessel, pipework, a pump, a building structure, or a bridge structure

12. A method for coating a substrate, comprising:
(a) combining (1) an isocyanate-functional component with (2) an isocyanate-reactive component comprising a hydroxyl-functional polymer in relative amounts to provide a ratio of isocyanate groups to hydroxyl groups in the combined composition of 0.5 to 5.0:1; and
(b) depositing the combined composition over at least a portion of a substrate, wherein the isocyanate-functional component comprises:
(i) an aliphatic polyisocyanate containing allophanate structural units and having the structure: 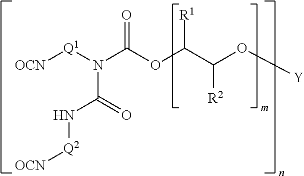
in which Q¹ and Q² independently of one another are the radical of an aliphatic diisocyanate, R¹ and R² independently of one another are hydrogen or a C₁-C₄ alkyl radical, Y is the radical of a starter molecule with a functionality of from 2 to 6, n is a number from 2 to 6, and m corresponds to a number of monomer units such that the number-average molecular weight of the polyether on which the structure is based is 300 to 20,000 g/mol; and
(H) a cycloaliphatic polyisocyanate comprising an allophanate group and an isocyanurate trimer group.

13. The method of claim 12, in which Q¹ and Q² are —(CH₂)₆—.

14. The method of claim 12, wherein the aliphatic polyisocyanate is prepared by a process comprising: (1) reacting a polyisocyanate (a) and a polyether polyol (b) that contains less than or equal to 0.02 milliequivalent of unsaturated end groups per gram of polyol, has a polydispersity of from 1.0 to 1.5 and an OH functionality of at least 1.9 to give an isocyanate-functional polyurethane polymer, and (2) partly or fully allophanatizing the urethane groups of the isocyanate-functional polyurethane polymer by further reaction with a polyisocyanate.

15. The method of claim 12, wherein the aliphatic polyisocyanate containing allophanate structural units corresponds to the general formula: 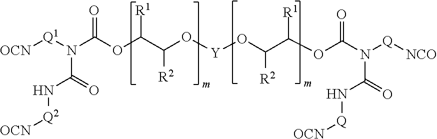
in which Q is —(CH₂)₆.

16. The method of claim 12, wherein the cycloaliphatic polyisocyanate is derived from isophorone diisocyanate and has: (i) an NCO content of 10% to 47% by weight, (ii) a viscosity of less than 10,000 mPas, and (iii) isocyanurate and allophanate groups in a molar ratio of monoisocyanurates to monoallophanates of 10:1 to 1:5.

17. The method of claim 12, wherein the isocyanate functional component comprises: (a) 50 to 90 percent by weight, based on the total weight of isocyanate-functional materials in the isocyanate-functional component, of the cycloaliphatic polyisocyanate; and (b) 10 to 50 percent by weight, based on the total weight of isocyanate-functional materials in the isocyanate-functional component, of the aliphatic polyisocyanate.

18. The method of claim 12, wherein the isocyanate-reactive component comprising a hydroxyl-functional acrylic polymer.

19. The method of claim 18, wherein the hydroxyl-functional acrylic polymer comprises a reaction product of reactants comprising:
(a) 10 to 40 percent by weight of one or more vinyl aromatic monomers;
(b) 5 to 40 percent by weight of one or more olefinic monomers containing hydroxyl groups;
(c) 10 to 30 percent by weight of one or more (meth)acrylic esters of an alcohol containing 1 to 8 carbon atoms; and
(d) 0.1 to 2 percent by weight of one or more (meth)acrylic acids, wherein the weight percents are based on the total weight of the reactants used to make the acrylic polymer.
